(19) United States
(12) Patent Application Publication
(10) Pub. No.: US 2022/0114382 A1
(43) Pub. Date: Apr. 14, 2022

(54) STRUCTURAL MEASUREMENT USING A FIXED PATTERN

(71) Applicant: Hewlett-Packard Development Company, L.P., Spring, TX (US)

(72) Inventor: Jacob Alexander Lowman, San Diego, CA (US)

(73) Assignee: Hewlett-Packard Development Company, L.P., Spring, TX (US)

(21) Appl. No.: 17/418,610

(22) PCT Filed: Jun. 5, 2019
(86) PCT No.: PCT/US2019/035519

§ 371 Date: Jun. 25, 2021

(51) Int. Cl. G06K 9/62; H04N 7/18; G05D 1/00

(52) U.S. Cl. CPC G06K 9/6215; G05D 1/0094; H04N 7/185

(57) ABSTRACT

Examples of devices are described herein. In some examples, a device may include a first image sensor to capture images of a fixed pattern that is in a static position relative to a structure. In some examples, the device may fly above the fixed pattern. In some examples, the device may include a measurement device to measure a distance from the device to the structure. In some examples, the distance may indicate a structural measurement relative to the fixed pattern and an offset between the first image sensor and the measurement device.

### BACKGROUND

Electronic technology has advanced to become virtually ubiquitous in society and has been used to improve many activities in society. For example, electronic devices are used to perform a variety of tasks, including work activities, communication, research, and entertainment. Some kinds of electronic devices control mechanisms to move. For instance, some electronic devices may control mechanisms to drive or fly. Examples of electronic devices include autonomous vehicles, unmanned aerial vehicles (UAVs), robots, computers, etc.

### BRIEF DESCRIPTION OF THE DRAWINGS

FIG. 1 is a simplified diagram illustrating an example of a device for structure measurement using a fixed pattern;

FIG. 2 is a flow diagram illustrating an example of a method for structural measurement using a fixed pattern;

FIG. 3 is a block diagram illustrating an example of a machine-readable storage medium for structural measurement using a fixed pattern; and

FIG. 4 is a block diagram of an example of a drone.

### DETAILED DESCRIPTION

Some techniques are described herein for measuring structures. A structure is an object or objects. For example, a structure may include an object, components or elements of an object, and/or attachments to an object. Some examples of structures include constructions, buildings, edifices, facilities, bridges, roads, houses, interior structures, exterior structures, artificial structures, natural structures, geologic features, mountains, hills, formations, immobile structures, stationary structures, machinery, vehicles, boats, airplanes, containers, cargo, shelves, etc.

In some cases, measuring a structure may be difficult to achieve. For example, some parts of a building may be elevated and/or may be difficult to access. Some approaches for measuring a structure may be difficult and/or costly to implement. Some examples of the techniques described herein may enable structural measurement that is less costly (e.g., that uses less expensive hardware and/or software), and/or that is less difficult to operate.

Some benefits of some examples of the techniques disclosed herein may include providing structural measurements with relatively inexpensive hardware and/or software (e.g., fixed pattern navigation instead of Global Positioning System (GPS), a simple laser measurement device instead of sophisticated LIDAR). Also, less user expertise or experience may be utilized to obtain the structural measurements in accordance with some examples of the techniques described herein, where simple drone flight such as vertical takeoff and/or hover may be utilized.

Throughout the drawings, identical or similar reference numbers may designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

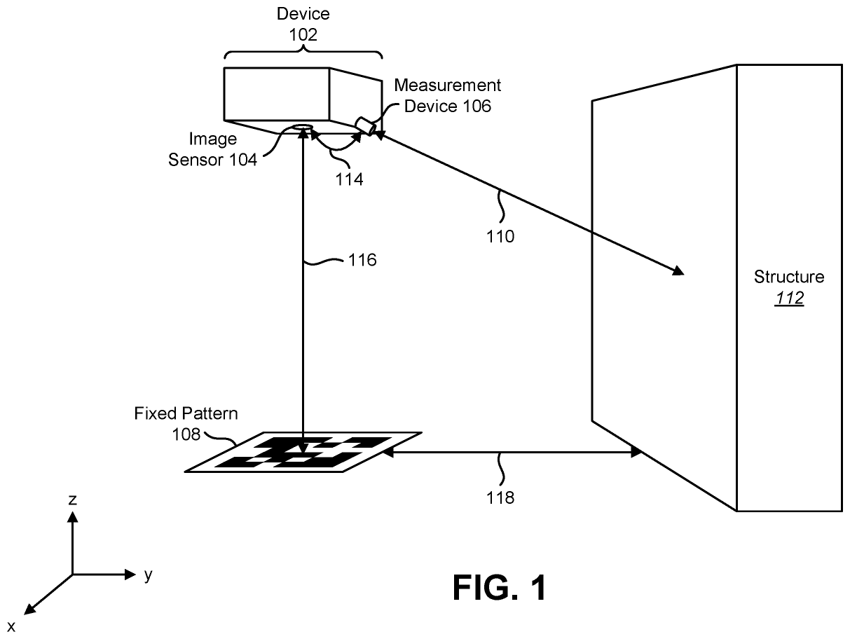

FIG. 1 is a simplified diagram illustrating an example of a device 102 for structure 112 measurement using a fixed pattern 108. The diagram is a perspective view with an example of x, y, and z axes. The device 102 is an electronic device that is capable of flight. Examples of the device 102 include unmanned aerial vehicles (UAVs), drones, remotely controlled helicopters, remotely controlled airplanes, remotely controlled dirigibles, balloon devices, etc. For instance, the device 102 may include a rotor(s), propeller(s), turbine(s), jet(s), gas reservoir(s), and/or balloon(s), etc., to enable the device 102 to fly in air (e.g., ascend, hover, float, etc.).

The device 102 may include an image sensor 104 to capture images. The image sensor 104 is a sensor that captures optical (e.g., visual) information. For example, the image sensor 104 may capture samples of light (in black and white and/or color). Examples of the image sensor 104 may include a digital camera, optical sensor chip (with a lens or lens assembly), etc. The image sensor 104 may capture a still image or still images, a series of burst images, a sequence of image frames, and/or video, etc.

In some examples, the image sensor 104 may capture images of a fixed pattern 108. The fixed pattern 108 is an optical pattern that is fixed in place. For instance, the fixed pattern 108 may be in a static position relative to the structure 112 (e.g., may not move relative to the structure 112 or may move negligibly with respect to the structure 112). For example, the fixed pattern 108 may be positioned at a fixed distance 118 from the structure 112. In some examples, the fixed pattern 108 (and/or the structure 112) may be fixed in place relative to Earth. For instance, the fixed pattern 108 may be placed on the ground or on a floor. In some examples, the fixed pattern 108 may be attached (e.g., staked, taped, weighted, etc.) to the ground or floor. The fixed pattern 108 may be marked (e.g., printed, drawn, manufactured) on a material (e.g., paper, plastic, wood, metal, combinations thereof, etc.).

In some examples, information about the static position (e.g., fixed distance 118) may be received. For example, a user may manually measure the static position (e.g., the fixed distance 118) (using a measuring tool such as a tape measure or a yardstick, for instance). In some examples, the user may input the information to the device 102 or to another device (e.g., a remote device such as a controller, computer, tablet device, smartphone, etc.). The other device may transmit the information to the device 102 in some examples. In some examples, the fixed pattern 108 may be on an item (e.g., pad, launch pad, landing pad, etc.) that includes an arm (that may extend to the structure 112) to establish the static position (e.g., fixed distance 118) of the fixed pattern 108. In some examples, the device 102 may be utilized to determine the static position (e.g., fixed distance 118) during a calibration procedure. For instance, the device 102 may utilize a measurement device 106 to measure the static position (e.g., fixed distance 118) of the fixed pattern 108 relative to the structure 112. For example, the calibration procedure may be performed while the device 102 is on the fixed pattern 108 (e.g., pad) before flying. In some examples, the device 102 may include structural (e.g., mechanical) features that interface with (e.g., interfere with) structural features of the pad such that the relationship between the fixed pattern 108 and the measurement device 106 is known during the calibration procedure in order to measure the static position (e.g., fixed distance 118).

The device 102 may fly above the fixed pattern 108 to capture the images of the fixed pattern 108. In some examples, the device 102 may be within an angular range from a vertical vector relative to the fixed pattern 108 (e.g., gravity vector, vector perpendicular to the fixed pattern 108, etc.). For example, the device 102 may fly above the fixed pattern 108 within a 15-degree angular range, 20-degree angular range, 30-degree angular range, 45-degree angular range, etc., of the vertical vector.

In some examples, the device 102 may include a processor to determine a position (e.g., translation and/or rotation) of the device 102 based on an image or images of the fixed pattern 108. For example, the device 102 may determine the position of the device 102 based on the size, position, and/or rotation of the fixed pattern 108 in the image(s). For example, a size of the fixed pattern in the image(s) may be utilized to determine an elevation 116 (e.g., vertical distance) above the fixed pattern 108. For instance, a relationship between the actual size of the fixed pattern 108 and the size of the fixed pattern 108 in the image(s) may indicate the elevation 116 (e.g., vertical translation) or distance between the device 102 and the fixed pattern 108. In some examples, the translation of the fixed pattern 108 in the image(s) may indicate a translation (e.g., horizontal translation in x and y) of the device 102. In some examples, the rotation and/or skew of the fixed pattern 108 in the image(s) may indicate a rotation (e.g., orientation) of the device 102.

In some examples, the fixed pattern 108 may be on a pad (e.g., launch pad and/or landing pad) for the device 102 that is separate from the structure 112. In some examples, the device 102 may be tethered to the pad. For example, the device 102 may be tethered (e.g., tied) to the pad with a cable, rope, string, chain, etc. The tethering may help to keep the device 102 within a distance from the pad and/or fixed pattern 108.

In some examples, the device 102 may include a measurement device 106 to measure a distance 110 from the device 102 to the structure 112. The measurement device 106 is a device for measuring distance based on light. Examples of the measurement device 106 include a laser measuring device and an infrared (IR) measuring device. For example, the measurement device 106 may be a single point laser measuring device. A single point laser measuring device may measure the distance to one point at a time. In some examples, the measurement device 106 may not be a continuously scanning laser (an in LIDAR, for instance). For instance, the single point laser measuring device may be much less costly to implement than a full LIDAR system. In some examples, the measurement device 106 may emit light (e.g., laser light or IR light, light signal, etc.) and determine an amount of time (e.g., time of flight) for the light to travel to the structure 112 and return to the measurement device 106. The amount of time may indicate the distance 110 to the structure 112.

The distance 110 may indicate a structural measurement relative to the fixed pattern 108 and an offset 114 between the image sensor 104 and the measurement device 106. A structural measurement is information indicating a location or position of a point of the structure 112. For example, the structural measurement may indicate a coordinate location (e.g., x, y, z coordinate position) of the point on the structure 112 relative to the fixed pattern 108 or the static position of the fixed pattern. The offset 114 is a spatial relationship between the measurement device 106 and the image sensor 104. For example, the offset 114 may be expressed as a translation, as a rotation, or as a combination of a translation and a rotation between the measurement device 106 and the image sensor 104. For instance, the measurement device 106 may be mounted to a gimbal or gimbals, and/or the image sensor 104 may be mounted to a gimbal or gimbals in some examples. The device 102 may track the offset 114 (e.g., measurement device 106 angle and/or image sensor 104 angle). The offset 114 may be utilized to determine the structural measurement. For example, the device 102 may track a pointing angle of the measurement device 106 relative to the image sensor 104 to determine the structural measurement. In some examples, the position (e.g., 3D coordinates, height, location, etc.) of the point of the structure 112 may be measured based on the distance 110, the offset 114, device 102 position (e.g., translation coordinates and rotation of the device 102), and the static position of the fixed pattern 108 (e.g., fixed distance 118).

In some examples, the device 102 may determine the structural measurement. For example, the device 102 may include circuitry (e.g., a processor, application-specific integrated circuit (ASIC), etc.) and/or memory (e.g., a computer-readable medium, memory cells, registers, etc.) to determine (e.g., calculate, compute, etc.) the structural measurement. For instance, the device 102 may utilize the distance 100, the offset 114, the device 102 position, and/or static position (e.g., fixed distance 118) of the fixed pattern 108 to determine the structural measurement. In some examples, another device (e.g., controller, computer, tablet device, smartphone, etc.) may determine the structural measurement. For example, the device 102 may include a transmitter to transmit the distance 100, the offset 114, the device 102 position, and/or static position (e.g., fixed distance 118) of the fixed pattern 108, which the other device may utilize to determine the structural measurement.

In some examples, the device 102 (and/or another device) may determine multiple structural measurements based on multiple distances measured by the device 102. For example, the device 102 may aim the measurement device 106 at different points to determine multiple distances 110 to respective points of the structure 112. Each of the distances 110 may be utilized (with other information at the time of the measurements, such as offsets 114 and device 102 positions) to determine each of the structural measurements. In some examples, a distance or distances between multiple structural measurements may be determined by the device 102 and/or another device. For example, a first structural measurement may be determined for a first point on the structure 112 and a second structural measurement may be determined for a second point on the structure 112. The device 102 or another device may utilize the two structural measurements (e.g., coordinates in 3D space) to determine the distance between the two structural measurements.

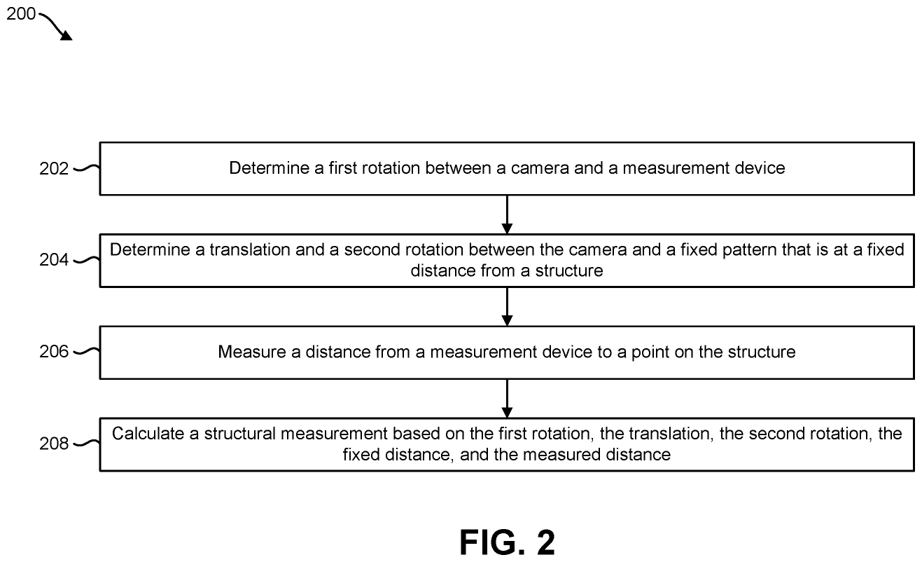

FIG. 2 is a flow diagram illustrating an example of a method 200 for structural measurement using a fixed pattern. In some examples, the method 200 may be performed by the device 102 described in connection with FIG. 1 and/or by a device in communication with the device 102.

The device 102 may determine 202 a first rotation between a camera and a measurement device 106. This may be accomplished as described in connection with FIG. 1. For example, the device 102 may track an angle of the measurement device 106 relative to the image sensor 104 (e.g., camera). For instance, the device 102 may track the angle based on gimbal pointing directions for the measurement device 106 and/or for the image sensor 104 (e.g., camera). The angle may be the offset 114 or a component of the offset 114. For example, the offset 114 may include the rotation component (e.g., a rotation or rotations for yaw, pitch, and/or roll) and a translation component (e.g., a shift or shifts in x, y, and/or z) that may be predetermined.

The device 102 may determine 204 a translation and a second rotation between the camera and a fixed pattern 108 that is at a fixed distance 118 from a structure 112. This may be accomplished as described in connection with FIG. 1. For example, the device 102 may determine a translation (e.g., elevation 116 and/or translation in x and/or y) based on the size and/or position of the fixed pattern 108 in an image or images captured by the camera. In some examples, the device 102 may determine the second rotation (e.g., yaw, pitch, and/or roll) of the device 102 based on an orientation (e.g., rotation and/or skew) of the fixed pattern 108 in the image or images captured by the camera. In some examples, the fixed pattern 108 is an asymmetrical pattern. For instance, using a symmetrical pattern may cause ambiguity in determining the orientation of the device 102, because there may be multiple potential orientations. An asymmetrical pattern may be utilized to enable the device 102 to recognize the fixed pattern 108 and/or to determine the orientation of the device 102 without ambiguity.

The device 102 may measure 206 a distance 110 from a measurement device 106 to a point on the structure 112. This may be accomplished as described in connection with FIG. 1. For example, the device 102 may record a time of flight of light (e.g., laser light, IR light, etc.) to the structure 112 and back to measure 206 the distance 110.

In some examples, the method 200 may include controlling the device 102 (e.g., a drone) to maintain a vertical position above the fixed pattern 108 while determining the first rotation, the translation, the second rotation, and while measuring the distance. For example, the device 102 may perform a control procedure to maintain an angular position within an angular range of a vertical vector above the fixed pattern 108 and/or within an elevation range above the fixed pattern 108. For instance, the device 102 may control a movement device or movement devices (e.g., rotor(s), propeller(s), turbine(s), jet(s), etc.) to compensate for drift caused by variations in the air (e.g., breeze, wind, temperature, etc.).

The device 102 may calculate 208 a structural measurement based on the first rotation, the translation, the second rotation, the fixed distance, and the measured distance. This may be accomplished as described in connection with FIG. 1. For example, the device 102 may mathematically calculate the structural measurement in coordinates (e.g., 3D coordinates, a grid position) based on relationships between the measured distance, the first rotation (e.g., offset), the translation, the second rotation, and the fixed distance.

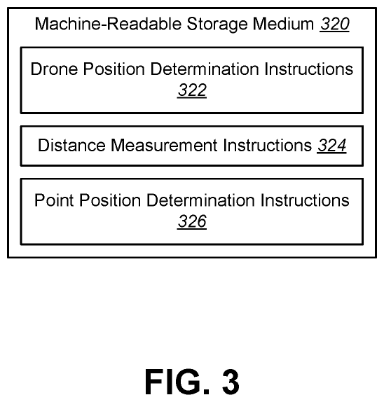

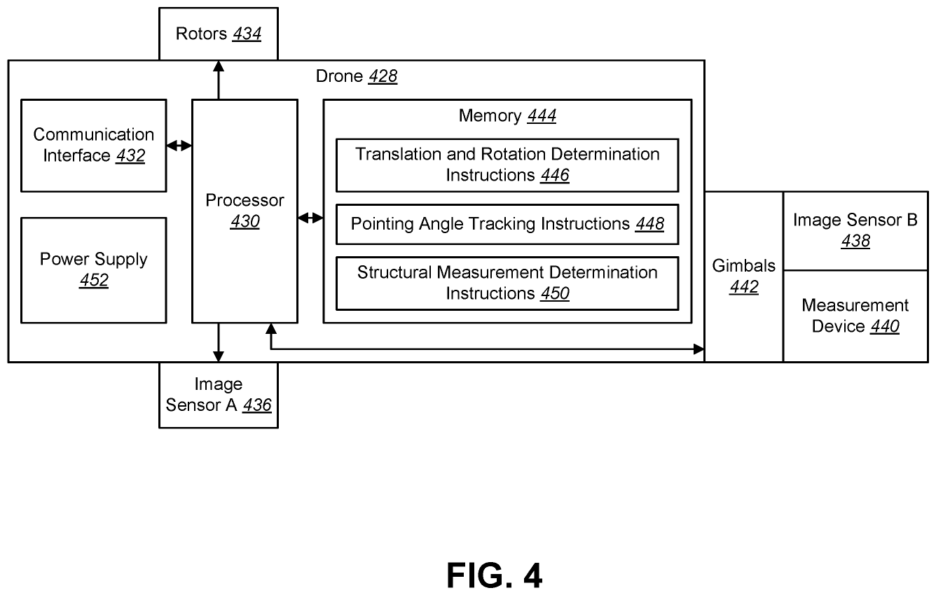

FIG. 3 is a block diagram illustrating an example of a machine-readable storage medium 320 for structural measurement using a fixed pattern. The machine-readable storage medium may be a non-transitory, tangible machine-readable storage medium 320. The machine-readable storage medium 320 may be, for example, random access memory (RAM), electrically erasable programmable read-only memory (EEPROM), a storage device, an optical disc, and the like. In some examples, the machine-readable storage medium 320 may be volatile and/or non-volatile memory, such as dynamic random access memory (DRAM), EEPROM, magnetoresistive random access memory (MRAM), phase-change random access memory (PCRAM), memristor, flash memory, and the like. In some implementations, the memory 444 described in connection with FIG. 3 may be an example of the machine-readable storage medium 320 described in connection with FIG. 3 or the machine-readable storage medium 320 described in connection with FIG. 3 may be an example of the memory 444 described in connection with FIG. 4.

The machine-readable storage medium 320 may include code (e.g., data and/or instructions). For example, the machine-readable storage medium 320 may include drone position determination instructions 322, distance measurement instructions 324, and/or point position determination instructions 326.

In some examples, the drone position determination instructions 322 are code to cause a processor to determine a three-dimensional (3D) position of a drone relative to a fixed pattern based on an image of the fixed pattern. The fixed pattern may be located at a fixed distance from a structure. For example, the drone position determination instructions 322 may be code to cause a processor to search an image to recognize a portion of the image that includes the fixed pattern (e.g., pixels representing the fixed pattern). The processor may determine the drone position based on the portion of the image in which the fixed pattern appears. In some examples, the processor may determine a drone orientation based on a rotation and/or skew of the fixed pattern. For example, the processor may determine a degree to which the fixed pattern is rotated and/or skewed in the image. For instance, if parallel lines of the fixed pattern appear closer together on one side of the fixed pattern in comparison to another side of the fixed pattern in the image, this may indicate that the drone is oriented with an amount of roll and/or pitch. In some examples, if the fixed pattern appears flatly rotated in the image, this may indicate that the drone is oriented with an amount of yaw. In some examples, the processor may store drone position information and/or drone orientation information in the machine-readable storage medium 320 and/or may transmit the drone position information and/or the drone orientation information to another device.

In some examples, the distance measurement instructions 324 are code to cause the processor to measure, using a laser, a distance between the drone and a point of the structure. For example, the distance measurement instructions 324 may be executed to operate a laser measurement device to determine the distance between the drone and the point of the structure.

In some examples, the point position determination instructions 326 are code to cause the processor to calculate a 3D position of the point based on the 3D position of the drone, the fixed distance, the distance, and a pointing orientation of the laser. For example, the point position determination instructions 326 may be executed to calculate a 3D coordinate position of the point relative to the fixed pattern using the fixed distance between the fixed pattern and the structure, the distance measured using the laser, and a pointing orientation of the laser that is based on a gimbal orientation.

In some examples, the machine-readable storage medium 320 may include code to cause the processor to calculate a 3D position of a second point of the structure. The machine-readable storage medium 320 may also include code to cause the processor to calculate a distance between the 3D position of the second point of the structure and the 3D position of the first point of the structure. For example, drone may adjust a pointing orientation of the laser from the first point to the second point to determine the 3D position of the second point. The code may be executed to determine a distance (e.g., length of a vector) between the first point and the second point based on the coordinates of each point.

FIG. 4 is a block diagram of an example of a drone 428. In this example, the drone 428 includes a processor 430 and a memory 444. The processor 430 executes instructions stored in the memory 444 to perform a variety of operations. For example, the processor 430 may run a program, which is a set of instructions or code that performs an operation when executed by the processor 430. The drone 428 may include a communication interface 432, a power supply 452, gimbals 442, rotors 434, image sensor A 436, image sensor B 438, and/or a measurement device 440. The drone 428 may include additional components (not shown) and/or some of the components described herein may be removed and/or modified without departing from the scope of this disclosure. In some examples, the drone 428 may be an example of the device 102 described in connection with FIG. 1, image sensor A 436 may be an example of the image sensor 104 described in connection with FIG. 1, and/or the measurement device 440 may be an example of the measurement device 106 described in connection with FIG. 1.

The processor 430 may be any of a central processing unit (CPU), a semiconductor-based microprocessor, field-programmable gate array (FPGA), an application-specific integrated circuit (ASIC), and/or other hardware device suitable for retrieval and execution of instructions stored in the memory 444. The processor 430 may fetch, decode, and/or execute instructions (e.g., translation and rotation determination instructions 446, pointing angle tracking instructions 448, and/or structural measurement determination instructions 450) stored on the memory 444. In some examples, the processor 430 may be configured to perform any of the functions, operations, techniques, methods, etc., described in connection with FIGS. 1-3 in some examples.

The memory 444 may be any electronic, magnetic, optical, or other physical storage device that contains or stores electronic information (e.g., instructions and/or data). Thus, the memory 444 may be, for example, random access memory (RAM), dynamic random access memory (DRAM), electrically erasable programmable read-only memory (EEPROM), magnetoresistive random-access memory (MRAM), phase change RAM (PCRAM), memristor, flash memory, a storage device, hard drive, magnetic disk, flash memory, and the like. In some implementations, the memory 444 may be a non-transitory machine-readable storage medium, where the term “non-transitory” does not encompass transitory propagating signals. The memory 444 may be coupled to the processor 430. An instruction set stored on the memory 444 may cooperate with the processor 430 (e.g., may be executable by the processor 430) to perform any of the functions, operations, methods, techniques, and/or procedures described herein.

Examples of instructions and/or data that may be stored in the memory 444 include translation and rotation determination instructions 446, pointing angle tracking instructions 448, and/or structural measurement determination instructions 450.

In some examples, the drone 428 may include a communication interface 432. The communication interface 432 may enable communication between the drone 428 and one or more other electronic devices. For example, the communication interface 432 may provide an interface for wireless communications. In some examples, the communication interface 432 may be coupled to one or more antennas (not shown in FIG. 4) for transmitting and/or receiving radio frequency (RF) signals. For example, the communication interface 432 may enable one or more kinds of wireless (e.g., personal area network (PAN), Bluetooth, cellular, wireless local area network (WLAN), etc.) communication.

In some examples, multiple communication interfaces 432 may be implemented and/or utilized. For example, one communication interface 432 may be a PAN (e.g., Bluetooth) communication interface 432, another communication interface 432 may be a Zigbee communication interface 432, another communication interface 432 may be a wireless local area network (WLAN) interface (e.g., Institute of Electrical and Electronics Engineers (IEEE) 802.11 interface), and/or another communication interface 432 may be a cellular communication interface 432 (e.g., 3G, Long Term Evolution (LTE), Code Division Multiple Access (CDMA), etc.). In some configurations, the communication interface(s) 432 may send information (e.g., structural measurement information, image information, measured distance information, offset information, control information, gimbal pointing information, video feed information, navigation information, position information, and/or orientation information, etc.) to an electronic device (e.g., controller, smart phone, tablet device, computer, server, etc.) and/or receive information (e.g., structural measurement information, control information, gimbal pointing information, and/or navigation information, etc.) from an electronic device (e.g., controller, smart phone, tablet device, computer, server, etc.).

The power supply 452 may supply power (e.g., electrical power, voltage, current, etc.) to the components of the drone 428. The power supply 452 may include a power source and/or circuitry for supplying power. For example, the power supply 452 may supply power to the communication interface 432, the processor 430, the memory 444, the rotors 434, image sensor A 436, the gimbals 442, image sensor B 438, and/or the measurement device 440. Some examples of the power supply 452 may include a battery, solar cells, etc.

In some examples, the processor 430 may control the rotors 434 to fly the drone. For example, the processor 430 may control the rotors 434 to ascend, to descend, to hover, to rotate, to adjust pitch, to adjust roll, to adjust yaw, and/or to maintain a position above a fixed pattern, etc.

In some examples, the measurement device 440 may be in a rigid mechanical relationship with image sensor B 438. For example, the measurement device 440 and image sensor B 438 may be attached to each other and/or may be included in a rigid housing. In some examples, image sensor B 438 and the measurement device 440 may be mounted to the gimbals 442. Image sensor B 438 and the measurement device 440 move together as adjusted by the gimbals 442. The gimbals 442 may be controllable by the processor 430 to point image sensor B 438 and the measurement device 440. Image sensor B 438 may provide a video feed showing a point of the structural measurement. For example, the measurement device 440 may be a laser measurement device that emits a laser beam. The endpoint of the laser beam may be within the field of view of image sensor B 438. Accordingly, image sensor B 438 may provide a video feed that may be communicated to another device (via the communication interface 432), where the other device may present the video feed on a display. This may enable a user to view the point on the structure that is being measured. In some examples, the other device may be a controller that receives input from a user. The input may be transmitted to the drone 428, which may receive the input via the communication interface 432. The processor 430 may utilize the input to control the gimbals 442 to point the measurement device 440 to a target point as indicated by the input.

In some examples, a graphic overlay or overlays (e.g., crosshairs, aim point, etc.) may be provided in an image (e.g., the video feed) from image sensor B 438 (e.g., a front-facing camera) to illustrate the location of the point. In some examples, depending on the measured distance provided by the measurement device 440, the overlay(s) may be adjusted to match the actual point. For example, the measurement device 440 (e.g., the pointing vector) may be pointed in parallel to the pointing direction of image sensor B 438, or the measurement device 440 (e.g., the pointing vector) may be pointed to intersect with the pointing direction of image sensor B 438 at a particular distance (e.g., 100 feet). Depending on the distance measurement, the overlay may be adjusted to mark or correspond to the actual point. In some examples, the measurement device 440 may provide a visible laser or measurement to provide a visual confirmation of the location of the point. In some examples, the measurement device 440 may provide an infrared (IR) signal, such that the point may be shown (in the video feed) from image sensor B 438 depending on the power of the IR signal and/or a filter used for image sensor B 438. In some examples, the measurement device 440 may utilize a signal that is not visible. The overlay(s) (e.g., crosshairs, aim point) may be utilized to show the point for a signal that is not visible. In some examples, a fixed crosshair or aim point overlay may be utilized, which may be accurate (e.g., have very small error between the overlay and the location of the point from the measurement device 440) for short to medium distances.

In some examples, image sensor A 436 is situated in a downward facing position to support navigation. For example image sensor A 436 may be utilized to capture an image or images of the fixed pattern, which may be utilized to determine the position of the drone 428. In some examples, determining the position of the drone 428 and/or determining the structural measurement may not utilize global positioning system (GPS) data. For instance, GPS data may not be utilized to calculate the structural measurement in some implementations. In some implementations, the drone 428 may utilize GPS data for another task, but may not utilize the GPS data in performing functions to determine the structural measurement.

In some examples, image sensor B 438 is situated in a side facing position to support measurement of the structure. For example, image sensor B 438 may be situated towards the structure being measured. In some examples, image sensor B 438 (e.g., images from image sensor B 438) may not be utilized for navigation purposes.

The processor 430 may be in electronic communication with the memory 444. As described above, the processor 430 may execute instructions (e.g., translation and rotation determination instructions 446 instructions, pointing angle tracking instructions 448, and/or structural measurement determination instructions 450) stored in the memory 444. The instructions may be loaded into the processor 430 for execution.

The processor 430 may execute translation and rotation determination instructions 446 to determine a translation (e.g., x, y, and/or z coordinates) and a rotation (e.g., roll, pitch, and/or yaw) of the drone 428 relative to the fixed pattern. For example, the translation and rotation determination instructions 446 may be executed to utilize an image or images from image sensor A 436 to determine the translation and/or rotation of the drone 428. Determining the translation and rotation of the drone 428 may be accomplished as described in connection with FIGS. 1, 2, and/or 3.

In some examples, the processor 430 may execute the pointing angle tracking instructions 448 to track a pointing angle of the measurement device 440 and/or image sensor B 438. For example, the processor 430 may track the pointing angle by recording angular pointing information of the gimbals 442. For instance, the processor 430 may maintain data indicating the current pointing angle of the measurement device 440 and/or image sensor B 438 as indicated by a state of the gimbals 442 and/or a command to adjust the gimbals 442. In some examples, the gimbals 442 may include sensors and/or actuators that indicate the pointing angle of the gimbals 442, which may be obtained and/or recorded by the processor 430. In some examples, the processor 430 may determine an offset between the measurement device 440 and image sensor A 436 based on the pointing angle. For example, the processor 430 may determine a difference between the pointing angle of the measurement device 440 and a pointing angle of image sensor A 436. In some examples, image sensor A 436 may have a fixed pointing angle with respect to the drone. In some examples, image sensor A 436 may be mounted to gimbals (not shown in FIG. 4) that may allow for changing a pointing direction of image sensor A 436. Accordingly, the offset between the measurement device 440 and image sensor A 436 may take into account a pointing angle of the measurement device 440 and a pointing angle of image sensor A 436. A pointing angle of image sensor B 438, a pointing angle of image sensor A 436, a pointing angle of the measurement device 440, and/or the offset may include pitch and/or yaw angles. In some examples, the pitch and/or yaw angles may be utilized as part of the calculation to determine a structural measurement.

In some examples, the processor 430 may execute the structural measurement determination instructions 450 to determine a structural measurement. For example, the processor 430 may determine a coordinate location of a point on a structure measured by the measurement device 440. For example, the processor 430 may calculate coordinates of the point relative to the fixed pattern and/or a vector from the fixed pattern to point based on the distance measured by the measurement device, the offset, the translation and rotation of the drone 428, and/or fixed distance between the fixed pattern and the structure.

In some examples, the processor 430 may send information to another device to perform the calculation to determine the structural measurement. For example, the processor 430 may send the distance measured by the measurement device 440, the offset (and/or pointing angle(s)), the translation and rotation of the drone 428, and/or the fixed distance between the fixed pattern and the structure to determine the structural measurement.

In some examples, the drone 428 (or another device) may determine a set of structural measurements of the structure. The set of structural measurements may be utilized to provide a 3D map of the structural measurements and/or a visualization of the structural measurements.

Some examples of the techniques described herein may provide structural measurement using a fixed pattern. Some examples may provide a relatively inexpensive drone-based measurement system using dual cameras, a laser measurement device, and a fixed pattern or fixed patterns for measuring structural dimensions. For instance, some implementations may utilize and/or include a drone with two cameras: a first camera that is a front mounted user controlled gimbal camera with a laser measure device attached. The second camera may be gimbal mounted and pointing down. A fixed pattern (e.g., ground target, launch pad, and/or grid) may be utilized. The drone may be potentially tethered to the fixed pattern. The fixed pattern with the drone may be positioned a fixed measured distance from a corner and/or edge of a structure. The drone may be launched straight up. The front camera may be aimed at a point for measurement, where software for the gimbals may be utilized to track camera position. The bottom camera may be aimed straight down, where software for the gimbals may be utilized to track camera position. The fixed pattern size and position in the captured image frame may be used to confirm height and position of the drone in relation to the fixed pattern. Based on the known distances and angles, basic structural measurements may be obtained.

While various examples of systems and methods are described herein, the systems and methods described herein are not limited to the examples. Variations of the examples described herein may be implemented within the scope of the disclosure. For example, operation(s), function(s), aspect(s), or element(s) of the examples described herein may be omitted or combined.

1. A device, comprising:
a first image sensor to capture images of a fixed pattern that is in a static position relative to a structure, wherein the device is to fly above the fixed pattern; and
a measurement device to measure a distance from the device to the structure, wherein the distance indicates a structural measurement relative to the fixed pattern and an offset between the first image sensor and the measurement device.

2. The device of claim 1, further comprising a processor to determine a position of the device based on the images of the fixed pattern.

3. The device of claim 1, further comprising a second image sensor, wherein the measurement device is in a rigid mechanical relationship with the second image sensor.

4. The device of claim 3, further comprising gimbals, wherein the second image sensor and the measurement device are mounted to the gimbals, and wherein the second image sensor is to provide a video feed to show a point of the structural measurement.

5. The device of claim 3, wherein the first image sensor is situated in a downward facing position to support navigation and the second image sensor is situated in a side facing position to support measurement of the structure.

6. The device of claim 1, further comprising a processor to track a pointing angle of the measurement device relative to the first image sensor to determine the structural measurement.

7. The device of claim 1, wherein the measurement device is a single point laser measuring device.

8. The device of claim 1, wherein the fixed pattern is on a launch pad for the device that is separate from the structure.

9. The device of claim 8, wherein the device is tethered to the launch pad.

10. The device of claim 8, wherein the launch pad comprises an arm to establish the static position of the fixed pattern.

11. A method, comprising:
determining a first rotation between a camera and a measurement device;
determining a translation and a second rotation between the camera and a fixed pattern that is at a fixed distance from a structure;
measuring a distance from the measurement device to a point on the structure; and
calculating a structural measurement based on the first rotation, the translation, the second rotation, the fixed distance, and the measured distance.

12. The method of claim 11, further comprising determining the translation and the second rotation based on a size, a position, and an orientation of the fixed pattern in an image captured by the camera, wherein the fixed pattern is an asymmetrical pattern.

13. The method of claim 11, further comprising controlling a drone to maintain a vertical position above the fixed pattern while determining the first rotation, the translation, the second rotation, and while measuring the distance.

14. A non-transitory machine-readable storage medium encoded with instructions executable by a processor, the machine-readable storage medium comprising instructions to:
determine a first three-dimensional (3D) position of a drone relative to a fixed pattern based on an image of the fixed pattern, wherein the fixed pattern is located at a fixed distance from a structure;
measure, using a laser, a distance between the drone and a point of the structure; and
calculate a second 3D position of the point based on the first 3D position, the fixed distance, the distance, and a pointing orientation of the laser.

15. The storage medium of claim 14, further comprising instructions to:
calculate a third 3D position of a second point of the structure; and
calculate a second distance between the third 3D position and the second 3D position.
